(19) United States
(12) Patent Application Publication
(10) Pub. No.: US 2009/0163582 A1
(43) Pub. Date: Jun. 25, 2009

(54) Stable Pesticide Concentrates and End-Use Emulsions

(76) Inventors: Yueh Wang, Arlington Heights, IL (US); Ian R. Gecker, Las Vegas, NV (US); John Lucas, Triy (GB); Ashish Shah, Edison, NJ (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/886,802

(22) PCT Filed: Apr. 4, 2006
(86) PCT No.: PCT/US2006/012391

§ 371 Date: Nov. 12, 2008

Related U.S. Application Data
(60) Provisional application No. 60/667,948, filed on Apr. 4, 2005.

(51) Int. Cl. A01N 43/30; A01N 53/06; A01N 43/08; A01P 7/00

(52) U.S. Cl. 514/464; 514/531; 514/520; 514/461

(57) ABSTRACT

Pesticide concentrates are provided containing an emulsifier that is an EPA list 4 inert and is a polyglycerol fatty acid ester, a sorbitan fatty acid ester or a combination thereof, a pesticide and a solvent that is either a EPA list 3 inert of acetyl ester, EPA list 4 inert of a methyl fatty ester, an acetyltributyl citrate, white mineral oil or a combination thereof. The pesticide can be a water-insoluble synthetic pyrethroid, natural pyrethrum, channel blocking insecticide, acetylcholinesterase inhibitor, oxadiazine, organophosphate, neonicotinoid insecticide, thiamethoxam, imidacloprid, acetamiprid, thiacloprid, clothianidin, nitenpyran, insect growth regulator, juvenile hormone mimic, fermentation insecticide, plant oil insecticide acaracide, miticide, fungicide, herbicide and combinations thereof. The pesticide concentrate is diluted with a hydrocarbon solvent, a white mineral oil or a combination thereof and mixed with water. A corrosion inhibitor is added to form a stable water-in-oil emulsion in conjunction with a propellant to make a ready-to-use aerosol for home, garden and public health pest control.

### FIELD OF THE INVENTION

The present invention relates to pesticide concentrates containing an emulsifier, a pesticide and a solvent. The pesticide concentrate may be diluted with solvent and mixed with water. These concentrates form stable water-in-oil emulsions. A corrosion inhibitor may also be added in conjunction with a propellant to make a ready-to-use aerosol for home, garden, professional or public health pest control.

### BACKGROUND OF THE INVENTION

The present invention generally relates to pesticide concentrates that can form stable water-in-oil emulsions with a propellant for use in ready-to-use pesticide aerosols or in pump/trigger sprays without a propellant.

Pesticides (which are defined herein to further include fungicides, acaricides, herbicides, insecticides, miticides, piscicides, pediculicides and bactericides) and pest repellants are normally formulated into various consumer products for use in home, garden, human and pet/animal pest control, for germ control and the like. The products may be formulated as aerosols, trigger sprays, powders or granules. Solvents, emulsifiers, stabilizers and fragrances are normally incorporated into such products to ensure the preparation of an environmentally acceptable, low mammalian toxicity, ready-to-use and efficacious product.

These formulation components are also selected to ensure that the pesticide composition will disperse or emulsify evenly in an aerosol or trigger sprayer at the point of application, to ensure stability in storage, to ensure optimum delivery of the pesticide preparation to the targeted pest or substrate and to provide the consumer with an efficacious and environmentally acceptable product. Some surfactants are not sufficient to fully ensure a stable water-in-oil emulsion for an aerosol preparation when the mixtures contain multiple components and the resulting oil-in-water emulsion may cause a corrosion problem in metal cans and a foaming problem in aerosol sprays. It may be necessary to add an antioxidant or a synergist to the insecticide to enhance biological activity, to provide chemical stability or to manage resistance.

Water-based aerosols are classified in terms of emulsion type. The primary categories are oil-in-water (o/w) emulsions and water-in-oil (w/o) or inverted emulsions.

Oil-in-water emulsions with high Hydrophil-Lipophil Balance (HLB) surfactants (i.e., in the range of 10-14), are by far the most common of the two types of emulsions. They typically produce large amounts of foam. Hydrophobic or lipophilic non-ionic surfactants of low HLB values (4-7) will usually produce water-in-oil emulsions.

Water-in-oil emulsions are primarily used in two general types of aerosol products: water-based air fresheners and water-based pesticides. They are low foaming, non-flammable and when optimally prepared form physically stable emulsions. W/O emulsions have less tendency to cause can corrosion. Volatile Organic Compound (VOC) regulations, emanating from the California Air Resources Board (CARB) and from the U.S. Environmental Protection Agency (EPA), which seek to lower the VOC content in consumer products, have made these formulation types virtually obligatory in the United States. On Jan. 9, 2004, the Canada PMRA issued Regulatory Directive 2004-1 Formulants Policy, which directs all pesticide registrants to reformulate their products with EPA list 3 and 4 inerts. Formulators can continue to use other inerts only if they label their products accordingly.

Early w/o aerosol emulsions often used a polyglyceryl-4 oleate as the preferred non-ionic emulsifier. Later emulsions used a fatty alkanolamide emulsifier which contains diethanolamine, a list 2 inert. The EPA and PMRA are moving toward allowing only list 3 and 4 inerts since these have a better and more complete toxicology database. Therefore, there is a need to identify effective and compatible emulsifiers for pesticide emulsions.

For aerosol air fresheners and most aerosol household pesticides, the volatile organic compounds are currently limited to 20-45% of the total weight of these products. To the great concern of the industry, CARB plans to further lower these limits to 25% or 15%. There is a significant formulation challenge to meet the requirements of lowering the VOC content yet still maintaining product stability and effectiveness. It is an object of the present invention to provide a pesticide formulation that meets the CARB's VOC limit and Canada's PMRA list 3 or 4 inert requirement, which is stable, effective, non-flammable and provides uniform spray atomization and coverage, ensures good efficacy and higher corrosion protection and can be produced in a cost effective manner.

U.S. Pat. No. 6,387,960 discloses an agricultural formulation containing monoglycerides that are used as emulsifiers, dispersants, wetting agents and solvents for adjuvant concentrates, pesticide concentrates and ready-to-use pesticide compositions.

U.S. Pat. No. 6,531,144 discloses a microemulsion aerosol composition including an insecticide, a mixture of sorbitan fatty ester and polyoxyethylene polyoxypropylene alkyl ether surfactants, an aliphatic hydrocarbon solvent, water and a liquefied petroleum gas as a propellant. The composition is a single phase formulation and does not require shaking the container containing the composition prior to use.

### BRIEF SUMMARY OF THE INVENTION

The present invention is directed to a pesticide concentrate that comprises an EPA list 4 inert emulsifier that is either a polyglycerol fatty acid ester, a sorbitan fatty acid ester or a combination thereof, a pesticide and a solvent that is either an EPA list 3 inert acetyl ester, an EPA list 4 methyl ester, acetyltributyl citrate or white mineral oil or combinations thereof.

Preferably, if the emulsifier is a polyglycerol fatty acid ester, it is a trigylcerol diisostearate or a decaglycerol hexaoleate and if the emulsifier is a sorbitan fatty acid ester, it is an ethoxylated sorbitan fatty acid ester such as polyoxyethylene sorbitan monooleate or a non-ethoxylated fatty acid ester such as sorbitan monooleate or a combination thereof.

Preferably, the pesticide can be a natural pyrethrum or synthetic pyrethroid such as permethrin, deltamethrin, bifenthrin, fluvalinate, fenvalerate, esfenvalerate, lambda cyhalothrin, tetramethrin, tralomethrin, cyfluthrin, resmethrin, sumithrin, imiprothrin, prallethrin (ETOC®), allethrin, bioallethrin, esbiothrin, s-bioallethrin (ESBIOL®), d-allethrin; cypermethrin; isomeric forms thereof such as zeta cypermethrin and tau fluvalinate; channel blocking insecticide such as a phenyl pyrazole (such as fipronil); acetylcholinesterase inhibitor such as a carbamate (such as carbaryl and bendiocarb); oxadiazines such as indoxacarb; organophosphate such as a chlorpyriphos (DURSBAN®) and acephate (ORTHENE®); neonicotinoid insecticide such as dinotefuran (SHURIKEN®); thiamethoxam; imidacloprid; acetamiprid; thiacloprid; clothianidin; nitenpyran; insect growth regulator such as benzoylphenyl urea (such as diflubenzuron (DIMILIN®), teflubenzuron, flufenoxuron, bistrifluoron, hexaflumuron); juvenile hormone mimic such as pyriproxifen (SUMILARV®), methoprene and fenoxycarb; fermentation insecticide such as abamectin, spiromesifen, spinosad and Bacillus thuringiensis; plant oil insecticide such as cinnamon, rosemary, wintergreen, citrus and clove oils; acaracide; miticide; fungicide; herbicide and combinations thereof.

More preferably, the pesticide is natural pyrethrum, a synthetic pyrethroid or combinations thereof.

Preferably, the pesticide concentrate further includes an additional solvent or synergist such as piperonyl butoxide, N-octylbicycloheptenedicarboximide, propargyl propyl phenylphosphonate and combinations thereof, an antioxidant such as ethoxyquin or tertiary butylhydroquinone (TBHQ), and an ultraviolet light absorber such as ethylhexyl methoxycinnamate or benzophenone, or other additives.

Preferably, a ready-to-use product contains the pesticide concentrate and further includes deionized or R/O (reverse osmosis) water, a diluent such as a hydrocarbon solvent, or a white mineral oil or a combination thereof, a corrosion inhibitor such as sodium benzoate and a propellant such as nitrogen, butane, isobutane, propane, hydrofluorocarbon, or combinations thereof.

The present invention is also directed to a process for treating a target substrate involving applying the ready-to-use aerosol or trigger spray product to the surface of the target substrate. The ready-to-use aerosol or trigger spray product is used for pest control and the target substrates include plants, homes, gardens, animals or pets such as dogs or humans.

Finally, the present invention is also directed to a process for making a pesticide concentrate and an end-use emulsion by mixing the components of the ready-to-use product together by conventional techniques.

These and other features, aspects, advantages of the present invention will become better understood with reference to the following description and appended claims.

### DETAILED DESCRIPTION OF THE INVENTION

Other than in the claims and in the operating examples, or where otherwise indicated, all numbers expressing quantities of ingredients or reaction conditions used herein are to be understood as being preceded in all instances by the term “about”.

The phrase “target substrate” as used herein means a household pest or germ, a home, a lawn or garden pest, a garden, a human, an animal, an animal pest, a human pest, or a combination of an animal and an animal pest or anything that carries a pest. A “pest” is defined as any living stage of any flying and crawling pest or plant pests such as weeds. An “animal pest” or a “pet pest” is defined as any living stage of pest such as a flea, tick, housefly, mosquito, cockroach, ant, worm, and mite, and also includes bacteria, fungi, other parasitic organisms or reproductive parts thereof, viruses, any organism similar to or allied with the foregoing or any infectious substances which can directly or indirectly cause harm in any animal, person, plant, structure (e.g., a home due to pests such as termites), pet or parts thereof.

The ready-to-use aerosol or trigger spray product can be, but is not limited to, consumer dilutable pesticide compositions for use in a pump up sprayer, a sprayer system and the like.

The dilutable pesticide concentrate can be used for, but is not limited to, flying or crawling pest control, larval or house-dust mite control, human headlice or bodylice control, pest repellent cloth treatment, flea or tick control or human/pet/animal care, or as a fungicide, a herbicide, a miticide or an acaracide on the target substrates.

The pesticide concentrate of the present invention includes an EPA list 4 inert emulsifier that is either a polyglycerol fatty acid ester, a sorbitan fatty acid ester or a combination thereof, a pesticide and a solvent that is either an EPA list 3 inert acetyl ester, an EPA list 4 methyl ester, acetyltributyl citrate or white mineral oil or a combination thereof.

Preferably, the pesticide can be a natural pyrethrum or synthetic pyrethroid such as permethrin, deltamethrin, bifenthrin, fluvalinate, fenvalerate, esfenvalerate, lambda cyhalothrin, tetramethrin, tralomethrin, cyfluthrin, resmethrin, sumithrin, imiprothrin, prallethrin (ETOC®), allethrin, bioallethrin, esbiothrin, s-bioallethrin (ESBIOL®), d-allethrin; cypermethrin; isomeric forms thereof such as zeta cypermethrin and tau fluvalinate; channel blocking insecticide such as a phenyl pyrazole (such as fipronil); acetylcholinesterase inhibitor such as a carbamate (such as carbaryl and bendiocarb); oxadiazines such as indoxacarb; organophosphate such as a chlorpyriphos (DURSBAN®) and acephate (ORTHENE®); neonicotinoid insecticide such as dinotefuran (SHURIKEN®); thiamethoxam; imidacloprid; acetamiprid; thiacloprid; clothianidin; nitenpyran; insect growth regulator such as benzoylphenyl urea (such as diflubenzuron (DIMILIN®), teflubenzuron, flufenoxuron, bistrifluoron, hexaflumuron); juvenile hormone mimic such as pyriproxifen (SUMILARV®), methoprene and fenoxycarb; fermentation insecticide such as abamectin, spiromesifen, spinosad and Bacillus thuringiensis; plant oil insecticide such as cinnamon, rosemary, wintergreen, citrus and clove oils; acaracide; miticide; fungicide; herbicide and combinations thereof.

Preferably, the pesticide concentrate further includes an additional solvent or synergist such as piperonyl butoxide, N-octylbicycloheptenedicarboximide, propargyl propyl phenylphosphonate and combinations thereof, an antioxidant such as ethoxyquin or tertiary butylhydroquinone (TBHQ), and an ultraviolet light absorber such as ethylhexyl methoxycinnamate or benzophenone.

More preferably, the pesticide is a water-insoluble natural pyrethrum, a synthetic pyrethroid or a combination thereof, with or without a synergist such as piperonyl butoxide and the emulsifier is preferably a trigylcerol diisostearate, a decaglycerol hexaoleate or a sorbitan monooleate and an ethoxylated sorbitan fatty acid ester blend. The ethoxylated sorbitan fatty acid ester is preferably a polyoxyethylene sorbitan monooleate or a monopalmitate.

Additionally, the end-use emulsion which includes the pesticide concentrate of the present invention, may include a hydrocarbon solvent such as an isoparaffinic fluid or a white mineral oil, an additional syngergist such as N-octylbicycloheptenedicarboximide or propargyl propyl phenylphosphonate, an antioxidant such as ethoxyquin, tertiary butylhydroquinone (TBHQ) or propyl gallate, an ultraviolet light (UV) absorber such as ethylhexyl methoxycinnamate or benzophenone, an air sanitizer such as triethylene glycol, dipropylene glycol or propylene glycol, a phenolic germicide such as o-phenylphenol or an alkylbenzyl quaternary ammonium salt, a corrosion inhibitor such as sodium benzoate, silicates, sodium nitrite or sodium phosphate, a propellant such as n-propane, n-butane, iso-pentane, iso-butane, n-pentane or hydrofluorocarbons, a floral or plant oil fragrance or deodorizer such as citrus, clove, eucalyptus, wintergreen, rosemary, citronella or cinnamon oil which also possesses pesticidal and antimicrobial properties, vegetable oils, additional biologically active ingredients as listed herein, and combinations thereof or other additives.

As used herein, the phrase “water-in-oil emulsion” also refers to dispersions and ready-to-use compositions. As used herein, the term “adjuvant” refers to an enhancing agent that improves the activity of the pesticide, such as a solvent, an emulsifier, a synergist, a UV absorber, a corrosion inhibitor, an antioxidant and a fragrance. As used herein, the phrase “biologically active ingredient” refers to any active ingredient or synergist in addition to the pesticide used in the formulation.

The low HLB polyglycerol fatty acid ester or sorbitan fatty acid ester surfactants used in the present invention can provide a variety of functions. They can serve as emulsifiers in the pesticide concentrate for making stable water-in-oil or inverted emulsions when a hydrocarbon or a white mineral oil solvent is added and the composition is mixed with water and a corrosion inhibitor. The polyglycerol fatty acid esters are EPA list 4A inerts (inerts which are generally regarded as materials having a lower toxicity), and sorbitan fatty acid esters are EPA list 4B inerts (inerts which have sufficient data to substantiate that they can be used in pesticide products with a lower toxicity). Polyglycerol esters are derived from esterification of fatty acids and polyglycerols. Particularly preferred polyglycerides for use in the present invention are triglycerol diisostearate and decaglycerol hexaoleate with a HLB value of 6 to 7.

Suitable low VOC solvents used in the present invention include, but are not limited to, acetate esters of C9-11 alcohols, technical white oil, methyl oleate, acetyltributyl citrate, an isoparaffinic fluid, vegetable oils such as canola oil, cotton seed oil, soybean oil and the like, and mixtures thereof, typically employed in agricultural adjuvants and pesticide compositions.

The preferred low VOC hydrocarbon or white mineral oil solvent used for diluting the pesticide concentrate to make an inverted emulsion of the present invention is technical white oil or an isoparaffinic fluid, used in an amount of from about 5% to about 20% by weight, preferably from about 10% to about 15% by weight, based on the weight of the water-based aerosol pesticide composition.

According to another embodiment of the present invention, there is provided a pesticide concentrate containing a mixture of a natural pyrethrum and a piperonyl butoxide synergist and/or a synthetic pyrethroid. Pyrethrum, tetramethrin or S-bioallethrin (ESBIOL®, marketed by Valent BioSciences Corporation) or other knockdown pyrethroids are typically used to provide the knockdown action and deltamethrin, permethrin or other kill pyrethroids are used primarily to provide killing activity and long residual control. Piperonyl butoxide (PBO) is used as a synergist to enhance the kill activity of the natural pyrethrum or synthetic pyrethroid against both flying and crawling insects. An EPA list 4 ethoxyquin antioxidant, which is soluble in a list 4 methyl oleate solvent, is used to effectively protect and stabilize the natural pyrethrum and the synthetic pyrethroid. Other pesticides that can be used in place of pyrethroids are listed above. This combination of pesticides and adjuvants or synergists provides a pesticide concentrate that provides both quick knockdown and long residual activity in an end-use aerosol or a trigger sprayer.

According to another embodiment of the present invention, there is thus provided a pesticide aerosol concentrate containing: (a) from about 5% to about 99.9% by weight, preferably from about 15% to about 95% by weight, and most preferably from about 20% to about 90% by weight, of the above-disclosed pesticides and synergists; and (b) from about 0.1% to about 95% by weight, preferably from about 5% to about 85% by weight, and most preferably from about 5% to about 80% by weight, of the adjuvants such as solvents, emulsifiers, antioxidants (note that antioxidants can also be considered as synergists), etc.

A process for making the stable water-in-oil emulsion of aerosol pesticide including the steps of mixing the pesticide concentrate containing the above-disclosed adjuvants (solvent, emulsifier, antioxidant) and/or synergists is also provided. The process further includes the dilution of the pesticide aerosol concentrate with a hydrocarbon solvent, a white mineral oil solvent or a combination thereof, then mixing the oil phase with a slow addition of deionized water and a corrosion inhibitor to form a stable and uniform water-in-oil emulsion.

More specifically, the process includes rapid agitation of the concentrate and the hydrocarbon solvent such as an isoparaffin or white mineral oil solvent (oil phase) by slowly adding deionized water containing a corrosion inhibitor (water phase) to ensure that a milky white and low-foaming water-in-oil emulsion has formed. Once all of the water is added, a stable, uniform and moderately viscous emulsion of 500 to 2000 cps (Brookfield) viscosity should form. The water-in-oil emulsion will then be transferred to a filling line by a low-shear pump, and mixed with a liquefied propellant to make a ready-to-use aerosol pesticide.

In another preferred embodiment of the invention, a ready-to-use aqueous pesticide composition is provided that contains from about 1.0% to about 15.0% by weight, and preferably from about 1.0% to about 10.0% by weight, based on the weight of the composition, of the above-disclosed pesticide concentrate, the remainder of which will typically be a solvent, a corrosion inhibitor, a propellant and water.

The invention will be understood more clearly from the following non-limiting representative examples as shown in the following tables. These examples show improved aerosol pesticide concentrates and end-use emulsions formulated with low VOC solvents and list 3 and list 4 inerts. Different formulations are designated via the letter and number codes shown herein.

The storage stability data throughout the examples are obtained from testing under 25° C. and accelerated storage conditions such as at a tropical temperature (25-40° C.) or at 54° C. The phrase “tropical conditions” refers to a regulated cycle at 25° C. to 40° C. for 8 hours, 40° C. for 4 hours, 40° C. to 25° C. for 8 hours and 25° C. for 4 hours.

All trademarks listed in the Examples are also listed in the Table at the end of this application.

### Example 1

### Low VOC Aerosol Concentrate Formulations

TABLE 1a
Composition of Knockdown (KD) Aerosol Concentrate

| | Low VOC | Low VOC |
|---|---|---|
| Components, Wt % | YW-88-1 | YW-78-1 |
| Deltamethrin tech 98% | 1.2 | 1.2 |
| ESBIOL ® tech 95% | 3.0 | 3.0 |
| EXXATE ® 1000 | 90.80 | |
| AGNIQUE ® ME 181-U | | 88.25 |
| EMEREST ® 2452 | 5.0 | 7.5 |
| TBHQ antioxidant | | 0.05 |

ESBIOL ® contains S-bioallethrin synthetic pyrethroid and is marketed by Valent BioSciences Corporation.
EXXATE ® 1000 (acetate ester of C9-11 alcohols, CAS#: 108419-34-7) is an EPA list 3 inert marketed by Exxon Mobile Chemical Corp.
AGNIQUE ® ME 181-U (methyl oleate, CAS#: 112-62-9) and
EMEREST ® 2452 (triglycerol diisostearate, CAS#: 63705-03-3) are EPA list 4 inerts marketed by Cognis Corp.

Table 1a shows the percent weight of the components of two improved Deltamethrin-ESBIOL® knockdown aerosol concentrate formulations, YW-88-1 and YW-78-1. Methyl oleate and triglycerol diisostearate are EPA list 4 inerts.

Briefly, the formulations are prepared as follows. First, the mixing tank is charged with a liquefied amount of EXXATE® 1000 or AGNIQUE® ME 181-U solvent. Then deltamethrin powder and ESBIOL® liquid insecticides are weighed, dissolved and mixed in the solvent. Finally, EMEREST® 2452 emulsifier and TBHQ antioxidant is added to the mixture and mixed for several minutes to complete the formulation.

TABLE 1b
Storage Stability of Knockdown (KD) Aerosol Concentrate

| | | Low VOC | Low VOC |
|---|---|---|---|
| | | YW-88-1 | YW-78-1 |
| Storage period | | 14 months | 17 months |
| Deltamethrin | Initial | 1.19 | 1.19 |
| | 25° C. | 1.20 (100%) | 1.17 (98%) |
| | Tropical (25-40° C.) | 1.19 (100%) | 1.18 (99%) |
| ESBIOL ® | Initial | 2.95 | 2.95 |
| | 25° C. | 2.86 (97%) | 2.83 (96%) |
| | Tropical (25-40° C.) | 2.87 (97%) | 2.82 (96%) |

Table 1b shows that the low VOC aerosol concentrates of Table 1a exhibit good storage stability after 14 or 17 months storage at 25° C. and tropical conditions.

### Example 2

### Low VOC Aerosol Formulations Prepared from the Concentrates of Example 1

TABLE 2a
Composition of Insecticide Aerosols

| | Low VOC | Low VOC |
|---|---|---|
| Components, Wt % | YW-88-2 | YW-61-1 |
| YW-88-1 | 1.75 | |
| YW-78-1 | | 1.75 |
| ISOPAR ® M | 12.50 | |
| PD ® 23 | | 12.50 |
| Sodium Benzoate | 0.20 | 0.20 |
| Deionized water | 71.05 | 71.05 |
| Propellant A-70 | 14.50 | 14.50 |

ISOPAR ® M (CAS# 64742-47-8) is an isoparaffinic fluid, an EPA list 2 inert marketed by Exxonmobil Chemical.
PD ® 23 is a technical white oil (CAS# 8042-47-5), an EPA list 4 inert, and marketed by Crompton Corporation. Inverted emulsions or 1.75% aerosol concentrate, 14.5% of A-70 propellant and 12.5% ISOPAR ® M or PD ® 23 solvent with deionized water and sodium benzoate corrosion inhibitor produce small spray particle size and leave no residue in can evacuation.

TABLE 2b
Storage Stability of formulation shown in Table 2a
(HPLC assays without propellant)

| | | YW-82-2 |
|---|---|---|
| Deltamethrin | Initial | .024 |
| | 6 mo/25° C. | |
| | Lined cans | .024 (100%) |
| | Unlined cans | .024 (100%) |
| | 6 mo Tropical | |
| | Lined cans | .023 (96%) |
| | Unlined cans | .023 (96%) |

Table 2b shows the storage stability of deltamethrin in composition YW-82-2 as shown in Table 2a.

### Example 3

### Low VOC Aerosol Concentrate Formulations

TABLE 3a
Composition of Permethrin Aerosol Concentrate

| | Low VOC | Low VOC | Low VOC |
|---|---|---|---|
| Components, Wt % | YW-50-6 | YW-66-1 | YW-66-2 |
| Permethrin tech (95%) | 12.5 | 12.5 | 12.5 |
| ISOPAR ® M | 80.0 | | |
| PD ® 23 | | 80.0 | 80.0 |
| EMEREST ® 2452 | 7.5 | 7.5 | |
| DREWPOL ® 10-6-O | | | 7.5 |

DREWPOL ® 10-6-O is a decaglyceryl hexaoleate (CAS# 65573-03-7) emulsifier marketed by the Stepan Company.

The formulations with the listed components are prepared in a similar manner as described in Example 1.

TABLE 3b
Storage Stability of formulation shown in Table 3a

| | | YW-50-6 |
|---|---|---|
| % Permethrin | Initial | 12.38 |
| | 6 mo/25° C. | 11.86 (96%) |
| | 6 mo/Tropical (25-40° C.) | 12.07 (98%) |

Table 3b shows that the low VOC aerosol concentrate formulation YW-50-6 of Table 3a is stable after six months storage at both 25° C. and under tropical conditions.

### Example 4

### Low VOC Aerosol Concentrate Formulations

TABLE 4a
Composition of Pyrethrum Aerosol Concentrates

| | | | Low VOC | Low VOC |
|---|---|---|---|---|
| | Low VOC | Low VOC | AS-0179- | AS-0179- |
| Components, Wt % | YW-54-3 | YW-54-3 | 82-1 | 82-2 |
| Pyrethrum 50% | 8.24 | 8.24 | 8.24 | 8.24 |
| Piperonyl Butoxide | 22.44 | 22.66 | 20.00 | 20.00 |
| ISOPAR ® M | 68.32 | 65.10 | | |
| PD ® 23 | | | 68.76 | 67.76 |
| EMEREST ® 2452 | 3.00 | 3.00 | 3.00 | 3.00 |
| RALUQUIN ® (96% | | | | |
| ethoxyquin) | | 1.00 | | 1.00 |

RALUQUIN ® is an ethoxyquin stabilizer (CAS# 91-53-2) from Raschig Corp, an EPA list 4 inert.

Table 4a shows four pyrethrum based aerosol concentrate formulations.

The formulations with the listed components are prepared in a similar manner as described in Example 1.

TABLE 4b
Storage Stability of two formulations shown in Table 4a

| | | YW-54-3 | YW-024-1 |
|---|---|---|---|
| Pyrethrum | Initial | 4.41 | 4.41 |
| | 6 mo/25° C. | 4.23 (96%) | 4.41* (100%) |
| | 6 mo/Tropical | 4.29 (97%) | 4.40* (100%) |
| PBO | Initial | 22.92 | 22.92 |
| | 6 mo/25° C. | 22.50 (98%) | 23.65* (103%) |
| | 6 mo/Tropical | 22.71 (99%) | 24.03* (105%) |

*8 month storage.

Table 4b shows storage stability data for two of the aerosol concentrate formulations listed in Table 4a. This data indicates that the pyrethrins (“pyrethrum” will be referred herein as “pyrethrins”) insecticide and PBO synergist are stable after 6 months storage at both 25° C. and under tropical conditions. The slight increase of PBO in YW-024-01 is due to running the HPLC analytical assays at different times which can result in greater variability in the data.

### Example 5

### Low VOC Aerosol Concentrate Formulations

TABLE 5
Composition of Aerosol Concentrates

| | List 4 Inert | List 4 Inert |
|---|---|---|
| Components, Wt % | AS-0179-74-1A | AS-0179-74-2 |
| Permethrin tech (95.8%) | 10.75 | 10.75 |
| Tetramethrin tech (93.1%) | 11.06 | 11.06 |
| Piperonyl Butoxide | 53.71 | 53.71 |
| AGNIQUE ® ME 181-U | 11.14 | |
| PD ® 23 | | 16.98 |
| SPAN ® 80 | 12.01 | |
| TWEEN ® 80 | 1.33 | |
| DREWPOL ® 10-6-O | | 7.5 |

SPAN ® 80 is sorbitan monoleate and TWEEN ® 80 is polyoxyethylene sorbitan monoleate, both marketed by Uniqema.

Table 5 shows two aerosol concentrate formulations containing the insecticides tetramethrin and permethrin as well as the synergist PBO.

The formulations with the listed components are prepared in a similar manner as described in Example 1.

Both of these list 4 inert formulations show good solubility of the active ingredient and the emulsifier at 40° F. storage and also meet Canada PMRA Regulatory Directive 2004-1 Formulation Policy.

### Example 6

### Low VOC Aerosol Concentrate Formulations

TABLE 6a
Composition of Aerosol Concentrates

| Components, Wt % | YW-67-2 | AS-84-1 | YW-67-7 |
|---|---|---|---|
| Pyrethrum 50% extract | 14.0 | 14.0 | 14.0 |
| Permethrin tech (92%) | 15.22 | 15.22 | 15.22 |
| BUTACIDE ® | 35.0 | 35.0 | 35.0 |
| ISOPAR ® M | 28.28 | | |
| PD ® 23 | | 15.78 | 28.8 |
| SPAN ® 80 | | 18.0 | |
| TWEEN ® 80 | | 2.0 | |
| EMEREST ® 2452 | 7.5 | | |
| DREWPOL ® 10-6-O | | | 7.5 |

BUTACIDE ® is a source of a technical piperonyl butoxide synergist marketed by Valent BioSciences.

The formulations with the listed components are prepared in a similar manner as described in Example 1.

TABLE 6b
Accelerated Storage Stability of two of the formulations
shown in Table 6a

% Pyrethrins/Permethrin/PBO

| | YW-67-2 | YW-67-7 |
|---|---|---|
| Initial | 6.65/13.51/27.94 | 6.86/13.93/28.81 |
| 54° C./2 Weeks | 6.80/13.78/28.86 | 6.85/13.90/29.00 |
| | (102%/102%/103%) | (100.0%/99.8%/101%) |

Table 6b shows accelerated storage stability data of pyrethrins, permethrin and PBO for two of the formulations listed in Table 6a. This data indicates that the low VOC formulations are stable after 2 weeks storage at 54° C. The slight increase of pyrthrins, permethrin or PBO is due to running the HPLC analytical assays at different times which can result in greater variability in the data.

### Example 7

### Low VOC Aerosol Formulations

TABLE 7a
Composition of Industrial Pest Killer Aerosols

| | Low VOC | Low VOC |
|---|---|---|
| Components, Wt % | YW-83-8 | YW-83-5 |
| PYRAPERM ® 7-14-35 | 2.86 | 1.43 |
| ISOPAR ® M or PD-23 ® | 10.0 | 10.0 |
| Sodium Benzoate | 0.2 | 0.2 |
| DI water | 72.44 | 73.87 |
| Propellant A-70 | 14.5 | 14.5 |

PYRAPERM ® 7-14-35 is a source of pyrethrins and permethrin pesticides containing piperon and is marketed by Valent BioSciences Corporation.

TABLE 7b
Storage Stability of one of the formulations shown in Table 7a

| | % Pyrethrins/Permethrin/PBO |
|---|---|
| | YW-83-8 |
| Initial | 0.23/0.47/0.93 |
| 6 mo/25° C. | |
| Unlined cans | 0.22/0.44/0.96 |
| | (95.7%/93.6%/103.2%) |
| 6 mo/Tropical (25-40° C.) | |
| Lined cans | 0.22/0.44/0.97 (3 mo) |
| | (95.7%/93.6%/104.3%) |
| Unlined cans | 0.22/0.44/0.97 |
| | (95.7%/93.6%/104.3%) |

The storage stability data of Table 7b shows that the pyrethrins, permethrin and PBO in formulation YW-83-8 of Table 7a are stable. The slight increase of PBO is due to running the HPLC analytical assays at different times which can result in greater variability in the data.

### Example 8

### Low VOC Aerosol Concentrate Formulations

TABLE 8a
Composition of Insecticide Aerosol Concentrates

| | Low VOC | Low VOC | Low VOC | Low VOC |
|---|---|---|---|---|
| Components, Wt % | YW-96-4 | YW-96-8 | YW-60-1 | YW-60-2 |
| SBP ® 1382 or | 11.0 | 11.0 | 11.0 | 11.0 |
| Resmethrin tech (91.7%) | | | | |
| BIOALLETHRIN ® | 6.8 | 6.8 | 6.8 | 6.8 |
| tech (94.4%) | | | | |
| EXXATE ® 1000 | 74.7 | 73.7 | | |
| AGRIQUE ® ME 181-U | | | 74.7 | 74.2 |
| EMEREST ® 2452 | 7.5 | 7.5 | 7.5 | 7.5 |
| RALUQUIN ® | | 1.0 | | 0.5 |

TABLE 8b
Storage Stability of one of the formulations shown in Table 8a

| | % Resmethrin/BIOALLETHRIN ® |
|---|---|
| | YW-96-4 |
| Initial | 10.09/6.62 |
| 16 mo/25° C. | 10.79(106.9%)/6.64(100.3%) |
| 16 mo/Tropical (25-40° C.) | 10.60(105.1%)/6.59(99.5%) |

This data indicates that the low VOC aerosol concentrate formulation YW-96-4 is chemically stable after 16 months storage at 25° C. and tropical conditions. The slight increase of Resmethrin or BIOALLETHRIN® is due to running the HPLC analytical assays at different times which can result in greater variability in the data.

### Example 9

### Low VOC Aerosol Formulations Prepared from the Concentrates of Example 8

TABLE 9a
Composition for Aqueous Pressurized Spray for Home & Garden

| | Low VOC | Low VOC |
|---|---|---|
| Components, Wt % | YW-97-4 | YW-61-2 |
| YW-96-4 | 2.0 | |
| YW-60-1 | | 2.0 |
| ISOPAR ® M or PD ® 23 | 12.5 | 12.5 |
| Sodium Benzoate | 0.4 | 0.4 |
| DI water | 70.6 | 73.1 |
| Propellant A-70 | 14.5 | 14.5 |

Table 9a shows formulations prepared from the concentrates of Table 8a.

TABLE 9b
Storage Stability of one of the formulations shown in Table 9a

| | % Resmethrin/BIOALLETHRIN ® |
|---|---|
| | YW-61-2 |
| Initial | 0.22/0.15 |
| 12 mo/25° C. | |
| Unlined cans | 0.22(100.0%)/0.16(106.7%) |
| Lined cans | 0.22(100.0%)/0.16(106.7%) |
| 12 mo/Tropical (25-40° C.) | |
| Unlined cans | 0.22(100.0%)/0.16(107.7%) |
| Lined cans | 0.22(100.0%)/0.15(100.0%) |

This data indicates that the low VOC aerosol formulation YW-61-2 is chemically stable after 12 months storage at 25° C. and tropical conditions with polymer coated or uncoated cans. The slight increase of BIOALLETHRIN® is due to running the HPLC analytical assays at different times which can result in greater variability in the data.

### Example 10

### Low VOC Aerosol Concentrate Formulations

TABLE 10a
Composition of Aerosol Concentrates

| | Low VOC | Low VOC |
|---|---|---|
| Components, Wt % | YW-001-2 | AS-86-1 |
| Pyrethrum 50% Extract | 10.0 | 10.0 |
| BUTACIDE ® | 55.6 | 50.0 |
| ISOPAR ® M | 31.9 | |
| PD ® 23 | | 31.9 |
| EMEREST ® 2452 | 2.5 | 2.5 |

The formulations with the listed components are prepared in a similar manner as described in Example 1. Formulation AS-86-1 contains all list 4 inerts.

TABLE 10b
Storage Stability of one of the formulations listed in Table 10a

| | % Pyrethrins/PBO |
|---|---|
| | YW-001-2 |
| Initial | 5.41/49.01 |
| 6 mo/25° C. | 5.81(107.4%)/51.01(104.1%) |
| 6 mo/Tropical (25-40° C.) | 5.76(106.5%)/50.55(103.1%) |

This data indicates that the low VOC aerosol concentrate formulation YW-001-2 is chemically stable after 6 months storage. The slight increase of pyrethrins or PBO is due to running the HPLC analytical assays at different times which can result in greater variability in the data.

### Example 11

### Low VOC Aerosol Concentrate Formulations

TABLE 11
Composition containing Deltamethrin

| Components, Wt % | YW-84-3 | YW-60-3 |
|---|---|---|
| Deltamethrin tech (99%) | 1.38 | 1.38 |
| EXXATE ® 1000 | 91.12 | |
| AGNIQUE ® ME 181-U | | 91.12 |
| EMEREST ® 2452 | 7.5 | 7.5 |

The formulations with the listed components are prepared in a similar manner as described in Example 1.

### Example 12

### Low VOC Aerosol Formulations Prepared from a Concentrate of Example 11

TABLE 12a
Composition of Low VOC Aerosols
prepared from the concentrate YW-84-3

| | Low VOC | Low VOC | Low VOC |
|---|---|---|---|
| Components, Wt % | YW-100-2 | YW-100-4 | YW-100-6 |
| YW-84-3 | 1.5 | 1.0 | 1.5 |
| ESBIOL ® tech (95.1%) | 0.16 | | |
| ISOPAR ® M or PD ® 23 | 12.5 | 10.0 | 10.0 |
| Sodium Benzoate | 0.2 | 0.2 | 0.2 |
| DI water | 73.64 | 74.3 | 73.8 |
| Propellant A-70 | 14.5 | 14.5 | 14.5 |

TABLE 12b
Storage Stability of a formulation shown in Table 13a

| | % Deltamethrin |
|---|---|
| | YW-100-6 |
| Initial | 0.026 |
| 3 mo/25° C. | |
| Unlined cans | 0.024(92.3%) |
| 3 mo/Tropical (25-40° C.) | |
| Unlined cans | 0.024(92.3%) |

The table below lists trademarks that are used in this application, the chemical component(s) which the trademarks are a source of, and the company which the trademarks belong to at the time of document preparation.

| TRADEMARKS | CHEMICAL COMPONENT | COMPANY |
|---|---|---|
| EMEREST ® 2452 | Triglycerol diisostearate | Cognis Corporation |
| DREWPOL ® 10-6-0 | Decaglycerol hexaoleate | Stepan Company |
| TWEEN ® 80 | Polyoxyethylene sorbitan | Uniqema |
| | monoleate | |
| TWEEN ® 40 | Polyoxyethylene sorbitan | Uniqema |
| | monpalmitate | |
| ISOPAR ® M | Isoparaffinic fluid | Exxon Mobil Chemical Corp |
| PD ® 23 | Technical white oil | Crompton Corporation |
| MGK ® 264 | N-octylbicycloheptenedi- | McLaughlin Gormley King |
| | Carboximide | Corporation |
| EXXATE ® 1000 | Acetate esters of C9-11 | Exxon Mobil Chemical Corp |
| | Alcohols | |
| AGNIQUE ® ME 181-U | Methyl oleate | Cognis Corporation |
| ESBIOL ® | S-bioallethrin synthetic | Valent BioSciences |
| | pyrethroid | Corporation |
| ULTRATEC ® | Deltamethrin | Valent BioSciences |
| | | Corporation |
| PERMANONE ® | Pyrethroid pesticide | Bayer AG |
| AMADOL ® 511 | Tall-oil fatty amide | Akzo Nobel Company |
| RALUQUIN ® | Ethoxyquin | Raschig Corp. |
| SPAN ® 80 | Sorbitan monoleate | Uniqema |
| TETRAPERM ® 10-10-50 | Tetramethrin and | Valent BioSciences |
| | permethrin pesticides and | Corporation |
| | synergist piperonyl butoxide | |
| BUTACIDE ® | Piperonyl butoxide | Valent BioSciences |
| | | Corporation |
| PYRAPERM ® 7-14-35 | Pyrethrins (pyrethrum) and | Valent BioSciences |
| | permethrin pesticides | Corporation |
| | containing piperonyl | |
| | butoxide | |
| AGRIQUE ® ME 181-1 | Methyl oleate solvent | Cognis Corp. |
| PYRENONE ® 5-50 | Pyrethrins (pyrethrum) | Bayer AG |
| | pesticides and piperonyl | |
| | butoxide | |
| CONSOL ® 170ES or | C10-15 cycloparaffinic & | Penreco Company |
| PENRECO ® 170ES | Isoparaffinic hydrocarbons | |
| BIOALLETHRIN ® | Pyrethroid pesticide | Valent BioSciences |
| | | Corporation |
| SBP ® 1382 | Resmethrin | Valent BioSciences |
| | | Corporation |

The formulations of the present invention were found to have anti-corrosion effects. These formulations can be contained in ready-to-use spray products which are useful for applying to substrates as stated above.

Changes can be made in the composition, operation and arrangement of the method of the present invention described herein without departing from the concept and scope of the invention as defined in the following claims:

We claim:

1. A stable pesticide concentrate comprising:
an emulsifier selected from the group consisting of a polyglycerol fatty acid ester, a sorbitan fatty acid ester and a combination thereof;
a pesticide; and
a solvent selected from the group consisting of an acetyl ester, a methyl ester, an acetyltributyl citrate, a white mineral oil, and combinations thereof.

2. The pesticide concentrate of claim 1 wherein the pesticide is selected from the group consisting of a water-insoluble synthetic pyrethroid, natural pyrethrum, channel blocking insecticide, acetylcholinesterase inhibitor, oxadiazine, organophosphate, neonicotinoid insecticide, thiamethoxam, imidacloprid, acetamiprid, thiacloprid, clothianidin, nitenpyran, insect growth regulator, juvenile hormone mimic, fermentation insecticide, plant oil insecticide, acaracide, miticide, fungicide, herbicide and combinations thereof.

3. The pesticide concentrate of claim 2 wherein the natural pyrethrum or synthetic pyrethroid is selected from the group consisting of permethrin, deltamethrin, bifenthrin, fluvalinate, fenvalerate, esfenvalerate, lambda cyhalothrin, tetramethrin, tralomethrin, cyfluthrin, resmethrin, sumithrin, allethrin, imiprothrin, prallethrin, bioallethrin, esbiothrin, s-bioallethrin, pynamin forte, cypermethrin and isomeric forms thereof.

4. The pesticide concentrate of claim 1 wherein the emulsifier is a polyglycerol fatty acid ester emulsifier.

5. The pesticide concentrate of claim 4 wherein the polyglycerol fatty acid ester emulsifier is trigylcerol diisostearate or decaglycerol hexaoleate.

6. The pesticide concentrate of claim 1 wherein the emulsifier is a sorbitan fatty acid ester.

7. The pesticide concentrate of claim 6 wherein the sorbitan fatty acid ester is sorbitan monooleate.

8. The pesticide concentrate of claim 6 wherein the sorbitan fatty acid ester is an ethoxylated sorbitan fatty acid ester.

9. The pesticide concentrate of claim 8 wherein the ethoxylated sorbitan fatty acid ester is polyoxyethylene sorbitan monooleate or monopalmitate.

10. The pesticide concentrate of claim 1 further comprising an additional solvent or a synergist.

11. The pesticide concentrate of claim 10 wherein said additional solvent or synergist is selected from the group consisting of piperonyl butoxide, N-octylbicycloheptenedicarboximide, propargyl propyl phenylphosphonate and combinations thereof.

12. The pesticide concentrate of claim 1 further comprising an antioxidant.

13. The pesticide concentrate of claim 12 wherein the antioxidant is ethoxyquin or tertiary butylhydroquinone.

14. The pesticide concentrate of claim 1 further comprising an ultraviolet light absorber.

15. The pesticide concentrate of claim 14 wherein the ultraviolet light absorber is selected from the group consisting of ethylhexyl methoxycinnamate, benzophenone and a combination thereof.

16. The pesticide concentrate of claim 1 further comprising an additional component selected from the group consisting of a fragrance, a deodorant, a sanitizer, a germicide and a combination thereof.

17. The pesticide concentrate of claim 1 further comprising deionized or reversed osmosis water, a diluent selected from the group consisting of a hydrocarbon solvent, a white mineral oil and a combination thereof, a sodium benzoate corrosion inhibitor and a propellant.

18. A ready-to-use product containing the pesticide concentrate of claim 1.

19. A method of using the product of claim 18, said method comprising applying the product for pest control to at least one member of the group consisting of plants, homes, animals, humans and a combination thereof.

20. The method of using the product of claim 19, comprising applying the product to the surface for pest control of at least one member of the group consisting of plants, homes, animals, humans and a combination thereof.

21. A process for making a stable pesticide concentrate comprising the steps of:
providing an emulsifier selected from the group consisting of a polyglycerol fatty ester, a sorbitan fatty acid ester and a combination thereof;
providing at least one pesticide; and
combining said emulsifier and said pesticide with a solvent selected from the group consisting of an acetyl ester, a methyl ester, acetyltributyl citrate or a white mineral oil and a combination thereof.

22. The process of claim 21 wherein the pesticide is selected from the group consisting of a water-insoluble synthetic pyrethroid, natural pyrethrum, channel blocking insecticide, acetylcholinesterase inhibitor, oxadiazine, organophosphate, neonicotinoid insecticide, thiamethoxam, imidacloprid, acetamiprid, thiacloprid, clothianidin, nitenpyran, insect growth regulator, juvenile hormone mimic, fermentation insecticide, plant oil insecticide, acaracide, miticide, fungicide, herbicide and combinations thereof.

23. The process of claim 22 wherein the natural pyrethrum or synthetic pyrethroid is selected from the group consisting of permethrin, deltamethrin, bifenthrin, fluvalinate, fenvalerate, esfenvalerate, lambda cyhalothrin, tetramethrin, tralomethrin, cyfluthrin, resmethrin, sumithrin, allethrin, imiprothrin, prallethrin, bioallethrin, esbiothrin, s-bioallethrin, pynamin forte, cypermethrin and isomeric forms thereof.
